(19) United States
(12) Patent Application Publication
(10) Pub. No.: US 2021/0299696 A1
(43) Pub. Date: Sep. 30, 2021

(54) PAINT ROLLER REMOVER

(71) Applicant: Michael Fain, Sautee, GA (US)

(72) Inventor: Michael Fain, Sautee, GA (US)

(21) Appl. No.: 17/102,426

(22) Filed: Nov. 23, 2020

Related U.S. Application Data
(60) Provisional application No. 62/903,834, filed on Sep. 21, 2019.

(51) Int. Cl. B05C 17/02

(52) U.S. Cl. CPC B05C 17/0245

(57) ABSTRACT

Implementations of a paint roller remover are provided. In some implementations, the paint roller remover comprises a first elongated member, a second elongated member, a connecting member, and a receiving space.

In some implementations, a method of using the paint roller remover comprises holding and moving the paint roller remover toward a roller cover of a paint roller, receiving and securing the roller cover with the paint roller remover, and removing the roller cover from the paint roller with the paint roller remover.

### CROSS REFERENCE TO RELATED APPLICATION

This application claims the benefit of U.S. Patent Application Ser. No. 62/903,834, which was filed on Sep. 21, 2019, and is incorporated herein by reference in its entirety.

### TECHNICAL FIELD

This disclosure relates to implementations of a paint roller remover.

### BACKGROUND

FIGS. 1A and 1B illustrate an example existing paint roller. Paint rollers are used to paint a surface with a rotating brush motion (as indicated in FIG. 1A) instead of the sliding brush motion of a typical paint brush. As shown in FIG. 1A, a typical paint roller includes a roller cover (or roller brush) and a roller frame. As shown in FIG. 1B, the roller frame includes a roller cage (or roller support) and a handle. As shown in FIG. 1A, the roller cover attaches to the paint roller by sliding over and around the roller cage, whereby the roller cage allows the roller cover to rotate on the roller frame when using the paint roller to apply paint to a surface. As shown in FIG. 1B, the roller cover is removable from the roller frame by pulling/sliding it off of the roller cage.

For typical use of a paint roller, the roller cover (and/or the roller cage or other portions of the roller frame) often needs to be cleaned, replaced, or otherwise maintained during or after completion of a painting task, such as painting a wall or ceiling. However, such cleaning, replacing, or other maintenance is often difficult to perform while the roller cover is installed on the paint roller. Yet, removing a roller cover that has been used (e.g., that is covered with paint) is often just as or even more difficult to do, as well messy and/or otherwise challenging. For example, often a user must use a plastic bag and/or pliers to remove a used roller cover. In some cases, a user even has to use a knife or other utensil to cut the dirty roller cover in order to remove it from the paint roller. Thus, often the roller cover is damaged as it is removed.

However, an apparatus does not currently exist that allows a user to easily and efficiently remove a dirty or otherwise used roller cover from a paint roller, such as without having to use a plastic bag and/or pliers as described above. Furthermore, such apparatus does not exist for removing such used roller cover without also damaging the roller cover, such as by cutting it with a knife or other utensil as described above.

### BRIEF DESCRIPTION OF THE DRAWINGS

FIGS. 1A and 1B illustrate an example existing paint roller.

FIGS. 2A and 2B illustrate implementations of an example paint roller remover according to the present disclosure.

FIGS. 3A-3C illustrate an example use of the paint roller remover according to the present disclosure.

### DETAILED DESCRIPTION

Implementations of a paint roller remover are provided. In some implementations, the paint roller remover comprises a first elongated member, a second elongated member, a connecting member, and a receiving space.

In some implementations, the paint roller remover is configured to secure (e.g., grab), remove, and hold a roller cover (or roller brush) from off of a paint roller. In some implementations, the roller cover may be dirty or otherwise used, for example after using the paint roller with the roller cover for a painting task, such as painting a wall or ceiling.

In some implementations, the paint roller remover is configured to grab, remove, and hold a roller cover from off of a paint roller by a user squeezing or otherwise compressing the paint roller remover.

In some implementations, the paint roller remover is configured to allow a user to easily and efficiently remove a dirty or otherwise used roller cover from a paint roller, such as without having to use a plastic bag and/or pliers as described below.

In some implementations, the paint roller remover is configured to allow a user to easily and efficiently remove a dirty or otherwise used roller cover from a paint roller without damaging the roller cover, such as by cutting the roller cover with a knife or other utensil as described below.

In some implementations, a method of using the paint roller remover comprises holding and moving the paint roller remover toward a roller cover of a paint roller, receiving and securing the roller cover with the paint roller remover, and removing the roller cover from the paint roller with the paint roller remover.

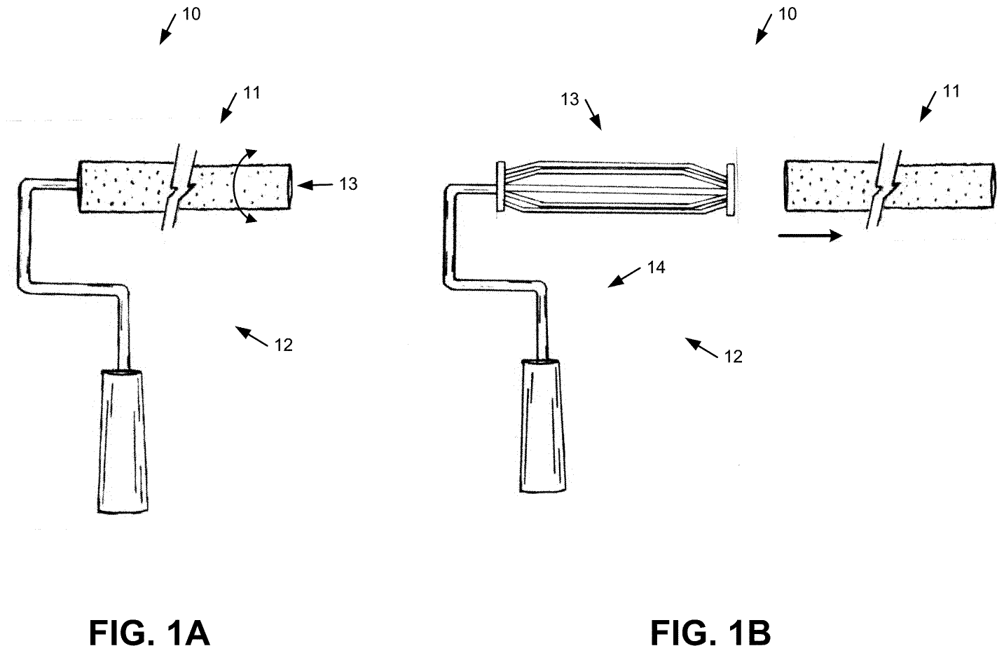

FIGS. 1A and 1B illustrate an example existing paint roller 10. Paint rollers 10 are used to paint a surface with a rotating brush motion (as indicated in FIG. 1A) instead of the sliding brush motion of a typical paint brush. As shown in FIG. 1A, a typical paint roller 10 includes a roller cover (or roller brush) 11 and a roller frame 12. As shown in FIG. 1B, the roller frame 12 includes a roller cage (or roller support) 13 and a handle 14. As shown in FIG. 1A, the roller cover 11 attaches to the paint roller 10 by sliding over and around the roller cage 13, whereby the roller cage 13 allows the roller cover 11 to rotate on the roller frame 12 when using the paint roller 10 to apply paint to a surface. As shown in FIG. 1B, the roller cover 11 is removable from the roller frame 12 by pulling/sliding it off of the roller cage 13.

For typical use of a paint roller 10, the roller cover 11 (and/or the roller cage 13 or other portions of the roller frame 12) often needs to be cleaned, replaced, or otherwise maintained during or after completion of a painting task, such as painting a wall or ceiling. However, such cleaning, replacing, or other maintenance is often difficult to perform while the roller cover 11 is installed on the paint roller 10. Yet, removing a roller cover 11 that has been used (e.g., that is covered with paint) is often just as or even more difficult to do, as well messy and/or otherwise challenging. For example, often a user must use a plastic bag and/or pliers to remove a used roller cover 11. In some cases, a user even has to use a knife or other utensil to cut the dirty roller cover 11 in order to remove it from the paint roller 10. Thus, often the roller cover 11 is damaged as it is removed from the paint roller 10.

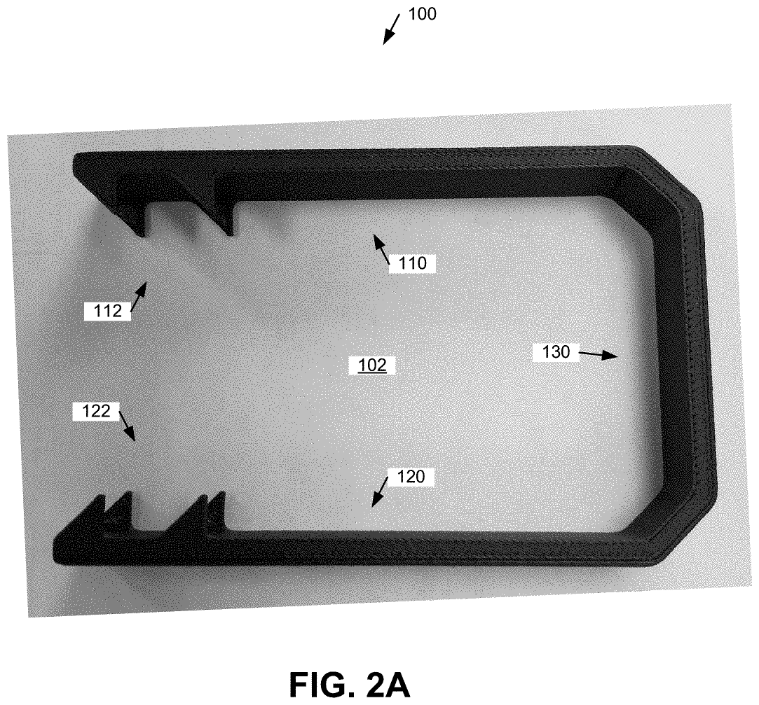

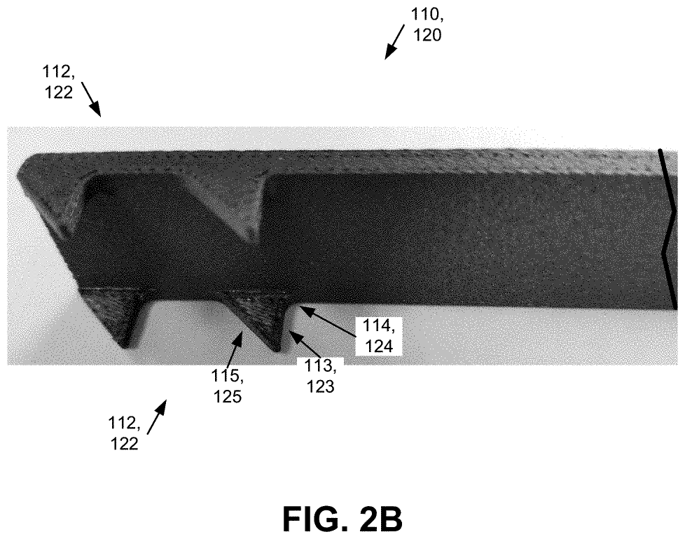

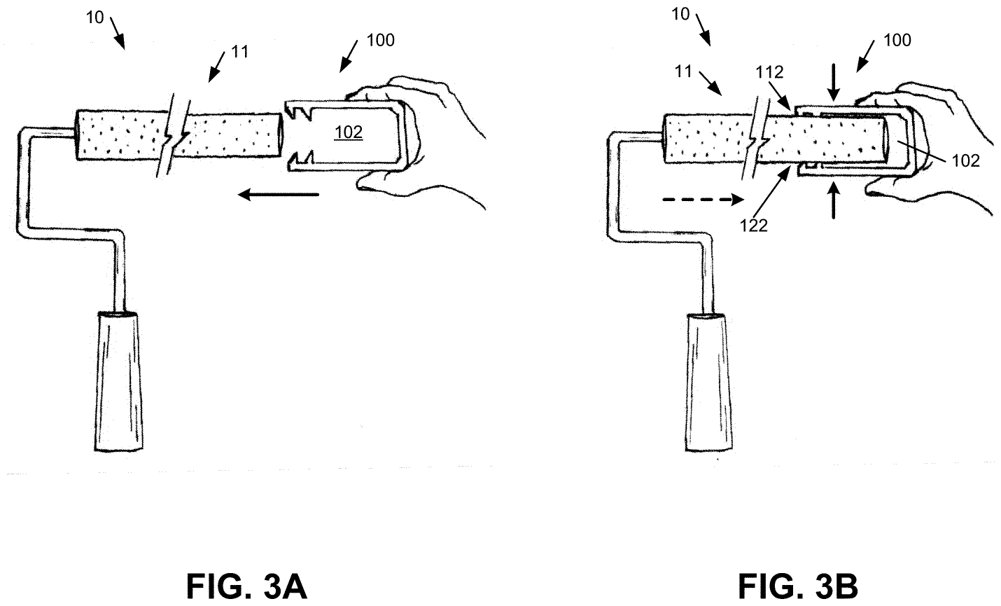

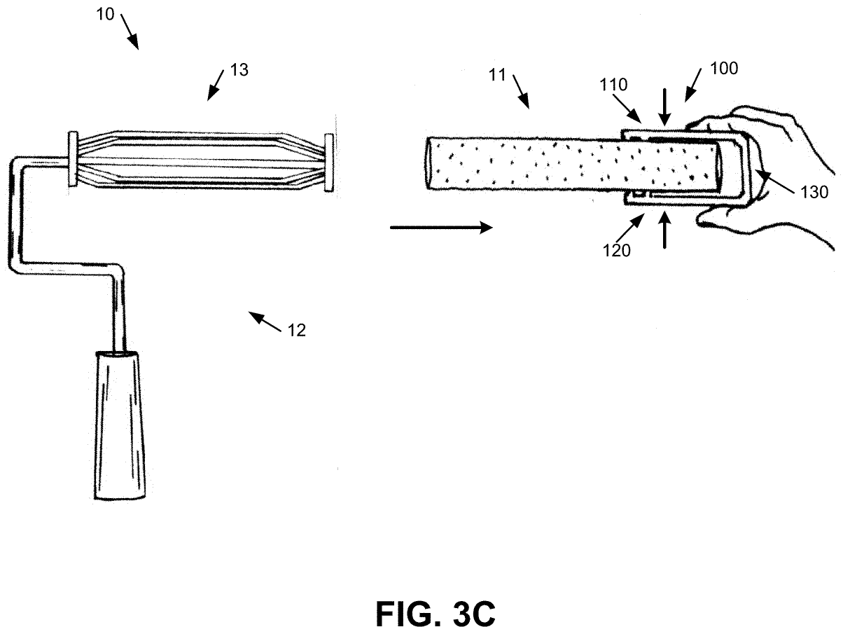

FIGS. 2A and 2B illustrate implementations of an example paint roller remover 100 according to the present disclosure. FIGS. 3A-3C illustrate an example use of the paint roller remover 100 according to the present disclosure.

As shown in FIG. 2A, in some implementations, the paint roller remover 100 comprises a first elongated member 110, a second elongated member 120, a connecting member 130, and a receiving space (“space”) 102.

As shown in FIG. 2A, in some implementations, the elongated members 110, 120 respectively extend parallel or generally parallel to each other and in the same direction away from a respective attachment or connection to the connecting member 130. In some implementations, the elongated members 110, 120 respectively extend perpendicularly or generally perpendicularly from the respective attachment to the connecting member 130.

As shown in FIG. 2A, in some implementations, the connecting member 130 extends between the attachment to the first elongated member 110 and to the second elongated member 120 such that the elongated members 110, 120 and the connecting member 130 form or generally form the U-shaped structure of the paint roller remover 100.

As also shown in FIG. 2A, in some implementations, the space 102 is formed between the elongated members 110, 120 extending from the connecting member 130.

As shown in FIG. 3C, in some implementations, the elongated members 110, 120 extend from the connecting member 130 such that the space 102 formed between the elongated members 110, 120 is wide enough (or otherwise configured) to receive a roller cover (or roller brush) 11 of a paint roller 10 therebetween the elongated members 110, 120 adjacent to the connecting member 130. Similarly, in some implementations, the connecting member 130 is long enough such that the elongated members 110, 120 extend perpendicularly or generally perpendicularly from each end of the connecting member 130 such that the space 102 is formed wide enough (or otherwise configured) to receive a roller cover 11 therebetween the elongated members 110, 120 adjacent to the connecting member 130.

Furthermore, as also shown in FIG. 3C, in some implementations, the elongated members 110, 120 are long enough to allow the paint roller remover 100 to be used to secure (e.g., grab), remove, and hold a roller cover 11 from off of a paint roller 10.

As shown in FIG. 3C, in some implementations, the elongated members 110, 120 are configured to be sufficiently flexible to allow the paint roller remover 100 to be squeezed or otherwise compressed to grab, remove, and hold a roller cover 11 from off of a paint roller 10.

As shown in FIG. 2A, in some implementations, the elongated members 110, 120 are straight or generally straight and have a rectangular prism shape or a generally rectangular prism shape. In some implementations, the elongated members 110, 120 may have any other suitable shape and/or features.

As shown in FIG. 2A, in some implementations, the connecting member 130 is straight or generally straight. In some implementations, the connecting member 130 may have offset or slanted bends near each end of the connecting member 130 adjacent to the respective attachments to the elongated members 110, 120. In some implementations, the connecting member 130 also has a rectangular prism shape or a generally rectangular prism shape. In some implementations, the connecting member 130 may have any other suitable shape and/or features.

As shown in FIG. 2A, in some implementations, the elongated members 110, 120 each comprise one or more grip teeth 112, 122 respectively. For example, in some implementations, the elongated members 110, 120 each comprise two grip teeth 112, 122 respectively.

In some implementations, the elongated members 110, 120 may each comprise one grip tooth 112, 122 respectively. In some implementations, the elongated members 110, 120 may each comprise more than two grip teeth 112, 122 respectively. In some implementations, the elongated members 110, 120 may each comprise any other suitable number of grip teeth 112, 122 respectively.

As shown in FIG. 2A, in some implementations, the grip teeth 112, 122 extend respectively from the elongated members 110, 120. In some implementations, the grip teeth 112, 122 so extend adjacent to the ends of the elongated members 110, 120 that are opposite from the ends adjacent to the attachment of the elongated members 110, 120 to the connecting member 130. In some implementations, the grip teeth 112, 122 extend respectively from the elongated members 110, 120 inward toward each other and the space 102 formed between the elongated members 110, 120.

As shown in FIG. 2B, in some implementations, each grip tooth 112, 122 comprises a triangular shaped projection that extends from the elongated members 110, 120 respectively. For example, as shown in FIG. 2B, in some implementations, the grip teeth 112, 122 comprise a right-triangle shape that respectively comprises a side 113, 123, a base 114, 124, and a sloping (e.g., hypotenuse) side 115, 125.

In some implementations, the base 114, 124 is attached parallel to the length of the elongated members 110, 120 respectively. In some implementations, the side 113, 123 extends perpendicular from the base 114, 124 respectively.

In some implementations, each side 113, 123 faces toward the connecting member 130. In some implementations, each sloping side 115, 125 faces away in the opposite direction from the connecting member 130, i.e. toward a roller cover 11 that is being removed using the paint roller remover 100. For example, in some implementations, the sides 113, 115, 123, 125 may be configured such that the grip teeth 112, 122 lean or slope respectively toward the connecting member 130, such as described more below.

In some implementations, the grip teeth 112, 122 may comprise any other suitable shape and/or features.

As shown in FIG. 2A, in some implementations, the grip teeth 112, 122 may be configured to lean or slope toward the connecting member 130. In this way, in some implementations, the grip teeth 112, 122 can further grab and/or otherwise engage a roller cover 11 when the paint roller remover 100 is squeezed or otherwise compressed and is pulled away from the paint roller 10 to remove the roller cover 11, as described more below.

As shown in FIG. 3B, in some implementations, the grip teeth 112, 122 are configured to allow the paint roller remover 100 to secure (e.g., grab), remove, and hold a roller cover 11 from off of a paint roller 10. For example, in some implementations, the grip teeth 112, 122 are configured to securely grab and hold a roller cover 11 of a paint roller 10. Furthermore, in some implementations, the grip teeth 112, 122 may be configured to securely grab and hold a roller cover 11 without damaging the roller cover 11, such as by causing cuts, tears, etc.

As shown in FIG. 2A, in some implementations, the paint roller remover 100 is U-shaped or generally U-shaped, such as formed by the elongated members 110, 120 and connecting member 130 as described above.

As shown in FIGS. 3A-3C, in some implementations, the paint roller remover 100 is configured to secure (e.g., grab), remove, and hold a roller cover (or roller brush) 11 from off of a paint roller 10. In some implementations, the roller cover 11 may be dirty or otherwise used, for example after using the paint roller 10 with the roller cover 11 for a painting task, such as painting a wall or ceiling.

In some implementations, the paint roller remover 100 is configured to grab, remove, and hold a roller cover 11 from off of a paint roller 10 by a user squeezing or otherwise compressing the paint roller remover 100. For example, as indicated in FIGS. 3B and 3C, in some implementations, the paint roller remover 100 is configured to grab, remove, and hold a roller cover 11 when an inward force or pressure is applied to the elongated members 110, 120.

In some implementations, the paint roller remover 100 is configured to allow a user to easily and efficiently remove a dirty or otherwise used roller cover 11 from a paint roller 10, such as without having to use a plastic bag and/or pliers as described above.

In some implementations, the paint roller remover 100 is configured to allow a user to easily and efficiently remove a dirty or otherwise used roller cover 11 from a paint roller 10 without damaging the roller cover 11, such as by cutting the roller cover 11 with a knife or other utensil as described above.

In some implementations, the paint roller remover 100 comprises any suitable dimensions, such as the examples described above.

In some implementations, the paint roller remover 100 is composed of any suitable materials, such as a durable, semi-flexible plastic material.

In some implementations, the paint roller remover 100 can have any suitable appearance, such as the appearance shown in FIG. 2A.

In some implementations, an example method of using the paint roller remover 100, with respect to the above-described figures, comprises holding the paint roller remover 100 and moving the paint roller remover 100 toward a roller cover (or roller brush) 11 of a paint roller 10, such as shown in FIG. 3A. As shown in FIG. 3B, in some implementations, the paint roller remover 100 is moved toward the roller cover 11 such that the roller cover 11 can be received within the space 102 between the elongated members 110, 120.

As shown in FIG. 3B, in some implementations, the method comprises receiving the roller cover 11 within the space 102 of the paint roller remover 100 and securing the roller cover 102 with the paint roller remover 100. In some implementations, the roller cover 11 is received within the space 102 by further moving the paint roller remover 100 toward the roller cover 11 such that the roller cover 11 is positioned at least partially with the space 102.

In some implementations, the roller cover 11 is secured by the elongated members 110, 120 being squeezed together, such as by a user of the paint roller remover 100. In some implementations, the roller cover 11 is secured by the roller cover 11 being held between the squeezed together elongated members 110, 120. In some implementations, the roller cover 11 is secured by the grip teeth 112, 122 grabbing the roller cover 102 while the elongated members 110, 120 are squeezed together.

As shown in FIG. 3C, in some implementations, the method comprises removing the roller cover 11 from the paint roller 10 with the paint roller remover 100. In some implementations, the roller cover 11 is removed by moving the paint roller remover 100 away from the paint roller 10 while the roller cover 11 is secured with the paint roller remover 100 as described above.

In some implementations, the secured and removed roller cover 11 can be held by the paint roller remover 100, such as shown in FIG. 3C. In some implementations, the roller cover 11 can thereafter be cleaned, discarded, or otherwise maintained. Furthermore, in some implementations, the roller cage 13 or other portions of the roller frame 12 can also be cleaned or otherwise maintained after the roller cover 11 has been removed.

The figures, including photographs and drawings, comprised herewith may represent one or more implementations of the paint roller remover.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A paint roller remover comprising:
a first elongated member, a second elongated member, and a third elongated member defining an interior space, wherein:
the first elongated member comprises a first end and a second end opposite the first end, wherein the first elongated member extends widthwise of the paint roller remover in a first direction;
the second elongated member comprises a first end and a second end opposite the first end, wherein:
the second elongated member extends widthwise of the paint roller remover in a second direction defining a first side of the paint roller;
the second elongated member extends from the first end of the first elongated member to the second end of the second elongated member; and
the second elongated member comprises one or more projections extending from the second elongated member adjacent to the second end of the second elongated member into the interior space;
the third elongated member comprises a first end and a second end opposite the first end, wherein:
the third elongated member extends widthwise of the paint roller remover in a third direction defining a second side of the paint roller opposite the first side;
the third elongated member extends from the second end of the first elongated member to the second end of the third elongated member; and
the third elongated member comprises one or more projections extending from the third elongated member adjacent to the second end of the third elongated member into the interior space;
the length of the first, second, and third elongated members are sized such that a roller brush of a paint roller can be at least partly received within the interior space between the second and third elongated members;
the second and third elongated members are flexible such that the second and third elongated members can be moved toward each other to grab and hold a roller brush of a paint roller at least partly received within the interior space between the second and third elongated members; and
the one or more projections extending from the second elongated member and the third elongated member are configured to grab a roller brush of a paint roller when the second and third elongated members are moved toward each other with the roller brush at least partly received within the interior space between the second and third elongated members.

2. The paint roller remover of claim 1 wherein the second direction and the third direction are parallel.

3. The paint roller remover of claim 2 wherein the second direction and the third direction are perpendicular to the first direction.

4. The paint roller remover of claim 1 wherein the one or more projections extending from the second elongated member and the third elongated member are triangular shaped.

5. The paint roller remover of claim 1 wherein the one or more projections extending from the second elongated member and the third elongated member extend angled partly toward the first member.

6. A method of using the paint roller remover of claim 1 comprising:
positioning a roller brush that is on a paint roller at least partly within the interior space between the second and third elongated members;
moving the second and third elongated members toward each other to grab and hold the roller brush between the second and third elongated members and with the one or more projections extending from the second elongated member and the third elongated member; and
removing the roller brush from the paint roller by moving the paint roller remover and the paint roller away from each other while grabbing and holding the roller brush with the paint roller remover.

7. A paint roller remover comprising:
a first elongated member, a second elongated member, and a third elongated member defining an interior space, wherein:
the first elongated member comprises a first end and a second end opposite the first end, wherein the first elongated member extends widthwise of the paint roller remover in a first direction;
the second elongated member comprises a first end and a second end opposite the first end, wherein:
the second elongated member extends widthwise of the paint roller remover in a second direction defining a first side of the paint roller;
the second elongated member extends from the first end of the first elongated member to the second end of the second elongated member; and
the second elongated member comprises one or more projections extending from the second elongated member adjacent to the second end of the second elongated member into the interior space;
the third elongated member comprises a first end and a second end opposite the first end, wherein:
the third elongated member extends widthwise of the paint roller remover in a third direction defining a second side of the paint roller opposite the first side;
the third elongated member extends from the second end of the first elongated member to the second end of the third elongated member; and
the third elongated member comprises one or more projections extending from the third elongated member adjacent to the second end of the third elongated member into the interior space; and
the second and third elongated members are flexible such that the second and third elongated members can be moved toward each other to grab and hold a roller brush of a paint roller at least partly received within the interior space between the second and third elongated members.

8. A method of using the paint roller remover of claim 7 comprising:
positioning a roller brush that is on a paint roller at least partly within the interior space between the second and third elongated members;
moving the second and third elongated members toward each other to grab and hold the roller brush between the second and third elongated members and with the one or more projections extending from the second elongated member and the third elongated member; and
removing the roller brush from the paint roller by moving the paint roller remover and the paint roller away from each other while grabbing and holding the roller brush with the paint roller remover.

9. A paint roller remover comprising:
a first elongated member, a second elongated member, and a third elongated member defining an interior space, wherein:
the first elongated member comprises a first end and a second end opposite the first end, wherein the first elongated member extends widthwise of the paint roller remover in a first direction;
the second elongated member comprises a first end and a second end opposite the first end, wherein:
the second elongated member extends widthwise of the paint roller remover in a second direction defining a first side of the paint roller;
the second elongated member extends from the first end of the first elongated member to the second end of the second elongated member; and
the second elongated member comprises one or more projections extending from the second elongated member adjacent to the second end of the second elongated member into the interior space;
the third elongated member comprises a first end and a second end opposite the first end, wherein:
the third elongated member extends widthwise of the paint roller remover in a third direction defining a second side of the paint roller opposite the first side;
the third elongated member extends from the second end of the first elongated member to the second end of the third elongated member; and
the third elongated member comprises one or more projections extending from the third elongated member adjacent to the second end of the third elongated member into the interior space;
the second and third elongated members are flexible such that the second and third elongated members can be moved toward each other to grab and hold a roller brush of a paint roller at least partly received within the interior space between the second and third elongated members; and
the one or more projections extending from the second elongated member and the third elongated member are triangular shaped and extend angled partly toward the first member.

10. A method of using the paint roller remover of claim 9 comprising:
positioning a roller brush that is on a paint roller at least partly within the interior space between the second and third elongated members;
moving the second and third elongated members toward each other to grab and hold the roller brush between the second and third elongated members and with the one or more projections extending from the second elongated member and the third elongated member; and
removing the roller brush from the paint roller by moving the paint roller remover and the paint roller away from each other while grabbing and holding the roller brush with the paint roller remover.
